(19) United States
(12) Patent Application Publication
(10) Pub. No.: US 2005/0169395 A1
(43) Pub. Date: Aug. 4, 2005

(54) Cost-effective multi-channel quadrature amplitude modulation

(76) Inventor: Peter Monta, Palo Alto, CA (US)

Correspondence Address: Howard M. Cohn;Patent Attorney, Suite 220, 21625 Chagrin Blvd., Cleveland, OH, 44122, US

(21) Appl. No.: 11/096,647

(22) Filed: Apr. 1, 2005

Related U.S. Application Data
(63) Continuation of application No. PCT/US04/06064, filed on Mar. 1, 2004.
(60) Provisional application No. 60/451,336, filed on Feb. 28, 2003.

(51) Int. Cl. H04K 1/10

(52) U.S. Cl. 375/261

(57) ABSTRACT

A highly-efficient, cost-effective technique for multi-channel QAM modulation is described. The technique employs an inverse fast-Fourier transform (IFFT) as a multi-channel modulator. QAM encoding expresses QAM symbols as constellation points in the complex plane such that each QAM symbol represents a specific phase and amplitude of a carrier frequency to which it is applied. In multi-channel systems, the carrier frequencies are generally uniformly spaced at a channel-spacing frequency (6 MHz, for digital cable systems in the United States). The IFFT accepts a set of complex frequency inputs, each representing the complex frequency specification (i.e., phase and amplitude) of a particular frequency. The inputs are all uniformly spaced, so assuming that the IFFT is sampled at a rate to provide the appropriate frequency spacing between its frequency-domain inputs, the IFFT will produce a time domain representation of QAM symbols applied to its various inputs modulated onto carriers with the desired channel separation. Since the channel spacing and the symbol rate are different due to excess channel bandwidth, interpolation is used to rectify the difference. An efficient scheme for combining this interpolation with baseband filtering and anti-imaging filtering is described.

### CROSS-REFERENCE TO RELATED APPLICATIONS

This application claims the benefit of U.S. Provisional Patent Application No. 60/451,336 filed on Feb. 28, 2003 which is incorporated herein by reference.

This application is a continuation of copending application PCT/2004/006064 filed on Mar. 1, 2004, which is incorporated herein by reference.

This application further relates to PCT/U.S. 2004/12488 filed on Apr. 21, 2004, which is incorporated herein by reference.

### TECHNICAL FIELD OF THE INVENTION

The present invention relates to digital data transmission systems, more particularly to multi-channel distribution of digitally-encoded data streams over a cable, optical fiber or similar transmission medium, and still more particularly to multi-channel QAM modulation of digital television data and related data sources.

### BACKGROUND

Over the last several years, there has been considerable growth in the availability of digital cable and satellite television broadcasting. As demand for digital programming continues to grow, cable television providers are transitioning from analog cable transmission systems and converters to mixed analog/digital and all-digital cable distribution systems. Increasing competition from digital satellite service providers has contributed to increased demand for more and different digital cable services including digital data services, interactive programming services and “on-demand” services like video-on-demand (VOD). A high-end variant of VOD, “everything-on-demand” (EOD) offers a dedicated, full-time video and audio stream for every user. An EOD stream can be used to view time-shifted TV, movies, or other content stored by content providers at the headend of the network, with full VCR-like controls such as pause, fast forward, random access with “bookmarks”, etc.

In combination with other services like interactive programming, cable Internet services, etc., these per-user services require considerably more infrastructure than do pure broadcast services. These newer, high-end services require a server subsystem to provide dynamically customized multi-program multiplexes on a per-user basis. Clearly, this requires a great deal of high-speed, high-performance processing, data routing, encoding and multiplexing hardware that would not otherwise be required.

As demand continues to grow for these high-end, per-user services, there is a growing need for more efficient, more cost-effective methods of creating large numbers of custom program multiplexes.

### SUMMARY OF THE INVENTION

The present inventive technique provides a highly efficient, cost-effective technique for multi-channel QAM modulation by employing an inverse fast-Fourier transform (IFFT) as a multi-channel modulator. QAM encoding expresses data symbols as constellation points in the complex plane space such that each QAM symbol represents a specific phase and amplitude of a carrier frequency to which it is applied. In multi-channel systems, the carrier frequencies are generally uniformly spaced at a channel-spacing frequency (6 MHz, for digital cable systems in the United States). The IFFT, acting as a synthesis uniform filterbank, accepts a set of frequency domain inputs, each representing a 6 MHz subband. The inputs are all uniformly spaced, so assuming that the IFFT is sampled at a rate to provide the appropriate frequency spacing between its frequency-domain inputs, the IFFT will produce a time domain representation of QAM symbols applied to its various inputs modulated onto carriers with the desired channel separation.

Typically, baseband filtering is applied to the QAM input streams to shape the baseband spectrum and, in cooperation with the receiver filtering, control inter-symbol interference. Also, anti-imaging filters are applied to the IFFT output to ensure proper channel separation.

According to an aspect of the invention, a typical multi-channel QAM modulator includes QAM encoding means, inverse FFT (IFFT) processing means, D/A conversion and upconversion. The QAM encoding means encode multiple digital input streams into multiple corresponding QAM symbol streams. The IFFT creates the desired modulation and channel spacing of the QAM symbol streams in an intermediate complex baseband, in digital form. The D/A conversion means convert the digital output from the IFFT conversion process into analog form, and the up-conversion means frequency shift the resultant multi-channel IF QAM signal up to a target frequency band to realize a multi-RF output for transmission.

According to an aspect of the invention, the digital data streams can be 256-QAM or 64-QAM encoded according to ITU specification J.83 Annex B.

According to an aspect of the invention, baseband filtering, anti-imaging and interpolation are all combined into a single post-IFFT time-varying digital filter stage.

In combination, then, one embodiment of a multi-channel QAM modulator for modulating a plurality of digital data streams onto a single multi-output is achieved by means of a set of QAM encoders, IFFT processing means, post-IFFT combined filtering means, D/A conversion means and up-converter means. The QAM encoders provide QAM symbol stream encoding of the digital data input streams. As described previously, IFFT processing performs parallel multi-channel QAM modulation in an intermediate frequency band. Post-IFFT combined filtering effective combines baseband filtering, anti-imaging filtering and rate interpolation into a single filtering stage. The D/A conversion converts IF output from the Post-IFFT filtering means from digital to analog form and the up-converter means frequency shifts the resultant analog signal into a target frequency band on a multi-RF output.

According to an aspect of the invention, digital quadrature correction means can be employed in the digital domain to pre-correct/pre-compensate for non-ideal behavior of the analog up-converter means.

According to another aspect of the invention, digital offset correction can be employed in the digital domain to pre-correct for DC offsets in the analog D/A conversion and up-converter means.

The present inventive technique can also be expressed as method for implementation on a Digital Signal Processor, FPGA, ASIC, or other processor.

According to the invention, multi-channel QAM modulation can be accomplished by providing a plurality of digital data input streams, encoding each of the digital data streams into a set of QAM-encoded streams, processing the QAM-encoded streams via an inverse FFT (IFFT) to modulate the plurality of QAM-encoded streams into a single digital multi-channel IF stream encoding the multiple QAM encoded streams onto a set of uniformly spaced carrier frequencies in an intermediate frequency band, converting the digital multi-channel IF stream to analog form; and frequency-shifting the analog multi-channel IF stream to a target frequency band onto a multi-RF output.

According to another aspect of the invention, the digital multi-channel IF stream can be post-IFFT filtered via a combined baseband and anti-imaging filter.

According to another aspect of the invention, the digital multi-channel IF stream can be interpolated to compensate for any difference between the QAM symbol rate and the channel spacing (sample rate).

According to another aspect of the invention, the digital multi-channel IF stream can be digitally quadrature corrected to pre-correct for non-ideal behavior of the frequency shifting process (in particular, the errors in an analog quadrature modulator).

According to another aspect of the invention, digital offset correction can be applied to compensate for DC offsets in the digital-to-analog conversion and frequency-shifting processes.

### BRIEF DESCRIPTION OF THE DRAWINGS

Reference will be made in detail to preferred embodiments of the invention, examples of which are illustrated in the accompanying drawings. The drawings are intended to be illustrative, not limiting. Although the invention will be described in the context of these preferred embodiments, it should be understood that it is not intended to limit the spirit and scope of the invention to these particular embodiments.

The structure, operation, and advantages of the present preferred embodiment of the invention will become further apparent upon consideration of the following description taken in conjunction with the accompanying drawings, wherein:

FIG. 1 is a block diagram of a multi-channel Quadrature Amplitude Modulation (QAM) modulator, in accordance with the prior art.

FIG. 2 is a block diagram of a direct translation of the multi-channel QAM modulator of FIG. 1 to digital form.

FIG. 3 is a block diagram of an all-digital multi-channel QAM modulator employing an Inverse Fast Fourier Transform, in accordance with the invention.

FIG. 4 is a block diagram of a simplified version of the multi-channel QAM modulator of FIG. 3, in accordance with the invention.

FIG. 5 is a block diagram of a preferred embodiment of a 16-channel QAM modulator, in accordance with the invention.

### DETAILED DESCRIPTION OF THE INVENTION

The present inventive technique provides an efficient, cost-effective means of multiplexing multiple “channels” of digital television and other data onto a single transmission medium.

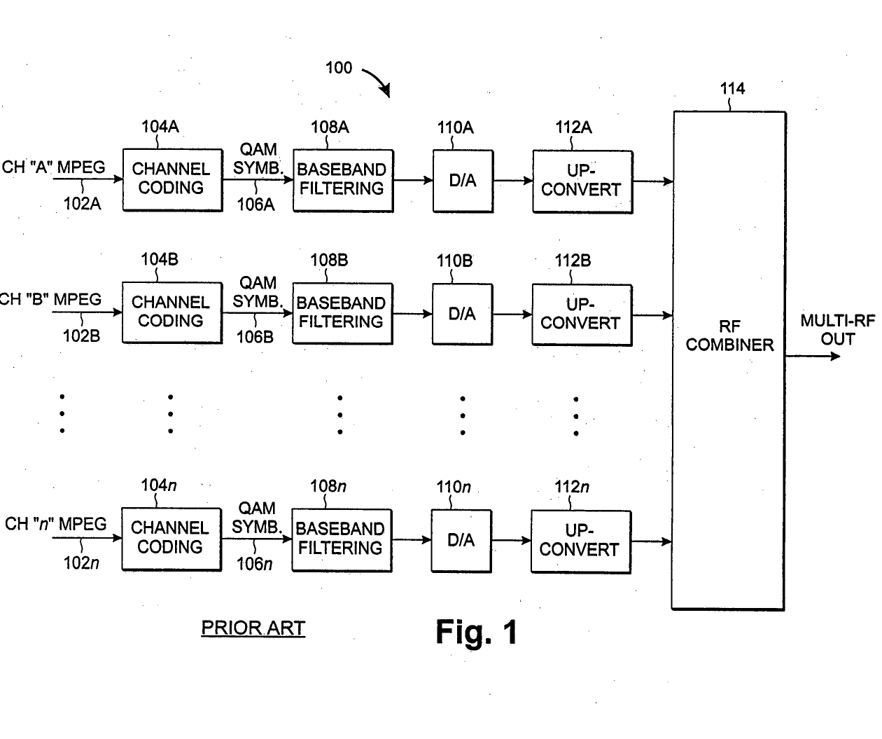

Most prior-art multi-channel QAM modulators are generally organized as shown in FIG. 1, which shows a system 100 of separate channel modulators being combined (summed) via an RF combiner 114 to produce a multi-channel RF output signal (Multi-RF Out). In FIG. 1, MPEG data streams 102A, 102B, . . . , 102n corresponding to “n” separate program sources are each encoded by a respective channel coder 104A, 104B, . . . , 104n to produce a respective QAM “symbol” stream 106A, 106B, . . . , 106n representing the MPEG data streams 102A, 102B, . . . , 102n. Each QAM symbol stream is encoded according to a suitable standard for digital cable television QAM stream encoding (e.g., ITU-T J.83 Annex A or Annex B, provided by the International Telecommunications Union, Geneva, Switzerland) whereby each QAM “symbol” represents one of a set of pre-defined phase/amplitude “constellation points” in complex frequency space. For example, 256-QAM defines a rectangular 16×16 array of constellation points in the complex plane. Each constellation point in the array represents a unique 8-bit binary value encoded at a specific carrier amplitude and phase angle. 64-QAM defines an 8×8 rectangular array of constellation points.

According to the United States frequency plan for digital cable television, channels are spaced in 6 MHz intervals, and are encoded at a symbol rate of 5.360537 Mbaud in the case of 256-QAM. (Other QAM modulation schemes such as 64-QAM and 1024-QAM are encoded at different symbol rates). Baseband filters 108A, 108B, . . . , 108n each receive a respective encoded 5.360537 Mbaud QAM symbol stream 106A, 106B, . . . , 106n and perform general channel “shaping”. (Most European systems operate at 8 MHz channel spacing). Outputs from the baseband filters 108A, 108B, . . . , 108n are then converted by respective digital-to-analog (D/A) converters 11A, 110B, . . . , 110n from digital to analog. Analog outputs from the D/A converters 11A, 110B, . . . 110n are each up-converted by a respective up-converter 112A, 112B, . . . , 112n to a respective channel frequency. Each up-converter 112‘x’ frequency-shifts an analog QAM-encoded stream from a respective D/A converter 110‘x’ to a specific channel frequency. Outputs from the up-converters 112A, 112B, . . . 112n are then combined (summed) onto a single multi-RF output by the RF combiner 114 for subsequent transmission over a suitable coaxial cable, fiber or hybrid fiber/coax (HFC) signal distribution network.

Those of ordinary skill in the art will immediately recognize that although inputs to the multi-channel modulator of FIG. 1 are shown as MPEG data streams, any suitable digital information source for which QAM or similar encoding can be defined may be employed. One example is DOCSIS data (Data Over Cable Service Interface Specification) whereby digital communications such as Internet communications can be encoded onto a digital cable television transmission medium. DOCSIS uses the MPEG transport stream as a convergence sublayer.

This multi-channel modulator 100 of FIG. 1 suffers from some inherent inefficiencies. First, the digital-to-analog (D/A) conversion happens too early in the process, and operates only on relatively low-bandwidth baseband streams. As a result, the relatively high sampling-rate capability of most modem D/A converters is wasted. Second, the up-converters each process only a single channel, occupying a tiny 6 MHz slice of the frequency spectrum. This results in poor converter utilization and high cost.

While the availability of a separate up-converter for each 6 MHz channel allows for tremendous frequency agility in that each channel can be placed independently of the others, this agility is not required by present-day applications, and is not envisioned for any future digital cable applications. Blocks of contiguous channels provide adequate flexibility for spectrum planning. (A user's set-top box does not care which RF channel is carrying a program; RF channels can be allocated almost completely arbitrarily among the spectrum channel slots, limited only by operational convenience.)

One approach to improving the cost-effectiveness of the multi-channel modulator of FIG. 1 is to translate as many of its analog components as possible—primarily the up-converters—into their digital equivalents and to move them back “behind” a single D/A converter. This greatly improves D/A converter utilization and eliminates the discrete up-converters. In this approach, numerically-controller oscillators (NCOs) would perform the function of local oscillators (LOs), digital multipliers would perform the function of doubly-balanced mixers, a digital adder would replace the analog RF combiner and digital filters would be employed to interpolate between the baseband channel QAM symbol rate (for example, 5.360537 Mbaud for 256-QAM) and a 6 MHz digital conversion rate that facilitates implementation of the 6 MHz channel spacing. This approach assumes that the additional cost of implementation of the new digital functions will be more than offset by the cost of the eliminated analog functions.

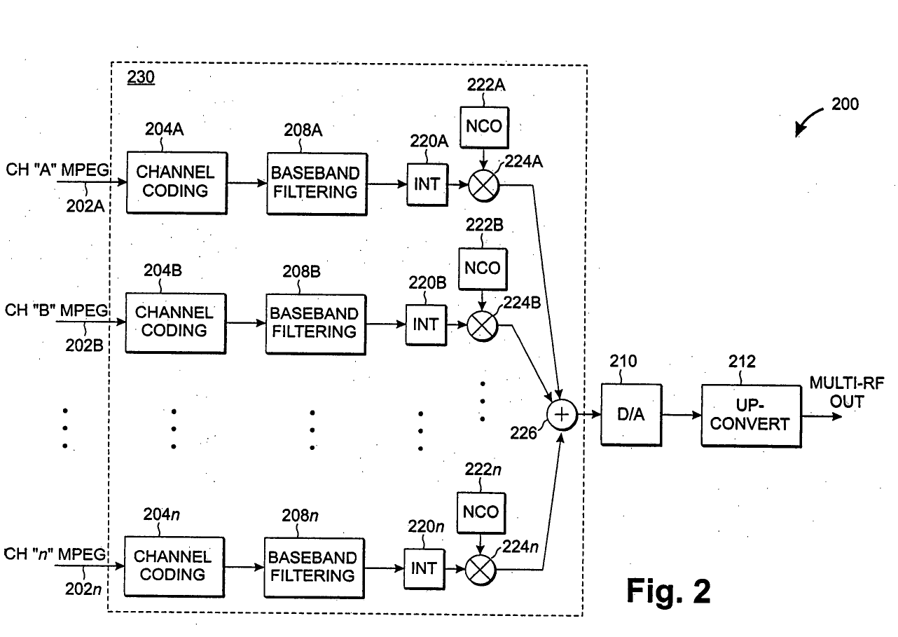

FIG. 2 is a block diagram of such an implementation. In FIG. 2, a multi-channel QAM modulator 200 comprises a digital processing block 230, followed by a single D/A converter 210 and up-converter 212. In the digital processing block 230, channel coders 204A, 204B, . . . , 204n (compare 104‘x’, FIG. 1) receive MPEG stream inputs (or other suitable digital stream data) and encode them according to a set of baseband QAM encoding rules (e.g., 256-QAM). QAM-encoded data from each channer coder 204A, 204B, . . . , 204n is then processed by a respective digital baseband filter 208A, 208B, . . . , 208n (compare 108‘x’, FIG. 1). The output of each baseband filter 208A, 208B, . . . , 208n is then processed by a respective digital interpolator 220A, 220B, . . . , 220n that compensates for the difference between the 5.360537 Mbaud QAM symbol rate and the 6n MHz D/A sample rate, where ‘n’ is the number of channels. Those of ordinary skill in the art will immediately understand that although the QAM symbol rate and channel spacing would be different under the European frequency plan, the principles remain the same and the same techniques are readily applied.

After interpolation, the output of each interpolator 220A, 220B, . . . , 220n is processed by a respective digital up-converter comprising a respective numerically controlled oscillator (NCO) 222A, 222B, . . . , 222n and a respective digital multiplier 224A, 224B, . . . , 224n. Each NCO 222‘x’ behaves as a digital equivalent of a local oscillator (LO) and each digital multiplier 224‘x’ behaves as a digital equivalent of a doubly balanced modulator (DBM or “mixer”). In combination, each NCO/multiplier pair (222‘x’/224‘x’) produces a digital output stream that digitally represents one QAM-coded channel upconverted to a different intermediate frequency. The outputs of the digital multipliers 224A, 224B, . . . , 224n are then summed together in a digital adder 226 to produce a multi-channel digital stream, encoding multiple properly-spaced QAM channels, but in an intermediate frequency (IF) band. This multi-channel digital stream is then converted to analog form by the D/A converter 210. A final up-converter 212 is used to frequency shift the entire analog IF multi-channel stream into the correct frequency band for transmission (Multi-RF out).

Two of the most significant factors in the cost of digital signal processing systems are the cost of the digital signal processors (DSPs) themselves and the cost of D/A converters. Semiconductor densities have exhibited an unabated exponential rate of increase for over 40 years. This trend predicts that any DSP-based or digital logic based technique will benefit over time from the increasing density and decreasing cost associated with digital circuitry. D/A converters are following similar density and cost curves, driven in part by the performance demands and high-volume production of digital cellular communications and wireless data communications markets.

Digital signal processing techniques can be implemented in a wide variety of technologies, ranging from full-custom dedicated function integrated circuits to ASICs (Application-Specific Integrated Circuits) to Field-Programmable Gate Arrays (FPGAs). Hardware description languages (HDLS) such as Verilog and VHDL in combination with logic synthesis techniques facilitate portability of digital designs across these various technology platforms. Each technology has its advantages and disadvantages with respect to development cost, unit pricing and flexibility, and all are capable of performing several hundred million digital operations per second.

Wideband digital-to-analog converters (also “D/A converters”, “D/As” or “DACs”) have already reached advanced stages of development. For example, the AD9744 from Analog Devices can convert 165 Ms/s with spur-free dynamic range of 65 dB for a cost of $11. This sample rate represents hundreds of video users, so the per-user cost is almost negligible.

The multi-channel modulator approach shown in FIG. 2 can be appropriate for situations where the channels are sparsely distributed over the spectrum, and it can be made fairly efficient by employing multi-rate techniques for the filters, for example, CIC (Cascade Integrator Comb) Filters. The cable-TV spectrum, however, is normally fully populated with uniformly spaced channels. This argues for a more efficient approach.

A significant efficiency improvement can be realized by recognizing that QAM encoding on uniformly spaced channels is simply a representation of a plurality of uniformly spaced, independent complex frequency components. This suggests the use of a transform-based technique to accomplish simultaneous up-conversion of a uniformly-spaced array of complex frequencies to a time-domain representation of a composite, multi-channel multiplex, as has been done for many years in applications such as FDM/TDM (Frequency Division Multiplex/Time Division Multiplex) transmultiplexers. By way of example, Fast Fourier Transform (FFT) techniques, a special case of the Discrete Fourier Transform (DFT), are well-known, well-defined, computationally efficient techniques for transitioning between time domain and frequency domain representations of signals. The Discrete Fourier Transform, which is in turn a special case of the more general continuous Fourier transform, represents a time-varying signal as the linear sum of a set of uniformly spaced complex frequency components. In its inverse form, the inverse DFT (IDFT) transforms a set of uniformly spaced complex frequency components (a frequency “spectrum” array) to its corresponding time-domain representation. The FFT and inverse FFT (IFFT) are computationally optimized versions of the DFT and IDFT, respectively, that take advantage of recursive structure to minimize computation and maximize speed.

If the QAM streams are expressed as a set of time-varying complex frequency coefficient pairs (i.e., Acos ωₙt+jBsin ωₙt, represented as a complex number [A,jB]) and assigned to a specific position in a complex IFFT's input array, and assuming that the IFFT is scaled and sampled such that the frequency spacing of its input array corresponds to the desired channel spacing, then the IFFT will produce a discrete time domain representation of all of the QAM streams modulated onto a set of uniformly spaced carriers and summed together. The IFFT, therefore, in a single computational block, effectively replaces all of the up-converters and local oscillators (NCOs/multipliers) of FIGS. 1 and 2.

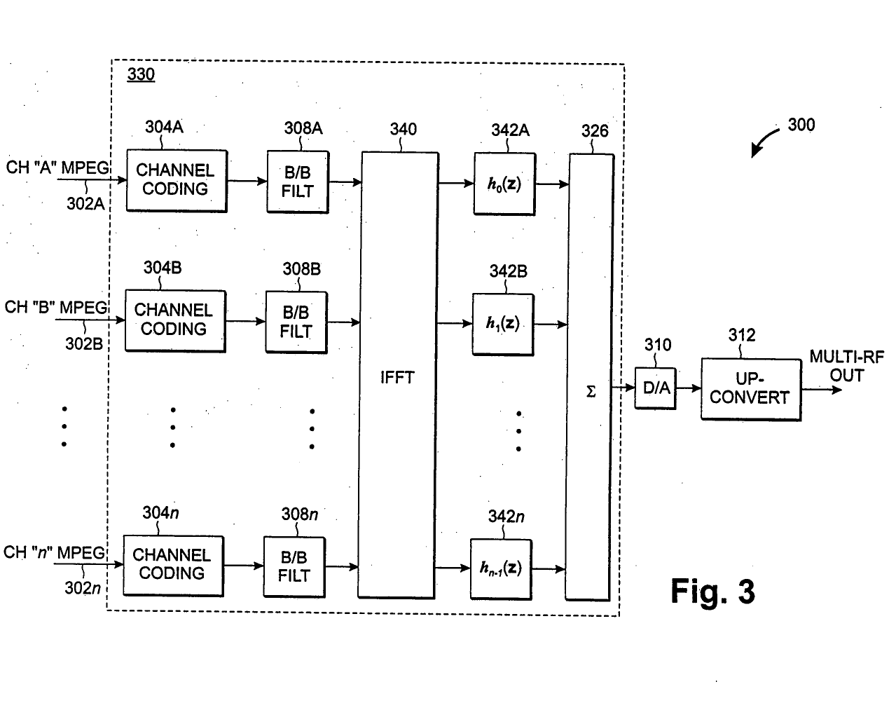

FIG. 3 is a block diagram of an IFFT-based implementation of a multi-channel QAM modulator 300. In FIG. 3, as in FIGS. 1 and 2, a plurality ‘n’ of MPEG input streams (or other suitable digital input stream) 302A, 302B, . . . , 302n are QAM encoded by a respective plurality of channel coders 304A, 304B, . . . , 304n and are subsequently processed by a respective plurality of baseband filters 308A, 308B, . . . , 308n to perform per-channel shaping on QAM-encoded complex frequency symbol streams produced by the channel coders 304‘x’, producing a set of complex frequency components. The resultant baseband-filtered QAM streams are then assigned to a respective complex frequency position in an IFFT input array and processed by an IFFT 340. While a number of transforms are suitable for realizing uniform filterbanks, (for example, discrete cosine transforms (DCTs)), in the interest of brevity and simplicity only the IFFT is discussed herein. The results of the IFFT 340 are processed by a set of ‘n’ anti-imaging filters 342A, 342B, . . . , 342n (h₀(z), h₁(z), . . . , hₙ₋₁(z)) to ensure proper channel isolation, and the outputs of the anti-imaging filters 342‘x’ are summed together by a digital adder 326 to produce a composite, multi-channel QAM-encoded digital time-domain stream, which is subsequently converted to analog by a D/A converter 310 and frequency shifted by an up-converter 312 into an appropriate frequency band to produce a multi-RF output.

The design of the modulator 300 of FIG. 3 employs two separate filtering stages:
a baseband filtering stage (308‘x’—pre-IFFT) and an anti-imaging filter stage (342‘x’—post-IFFT). Although this scheme can be employed successfully, the split between the filtering stages is awkward and requires considerable attention to the design of the baseband and anti-imaging filters to ensure that their cascaded effect through the IFFT produces the desired results. Further, the use of two separate digital filtering stages is costly in circuitry and/or computations, requiring separate circuitry and/or computations for each stage.

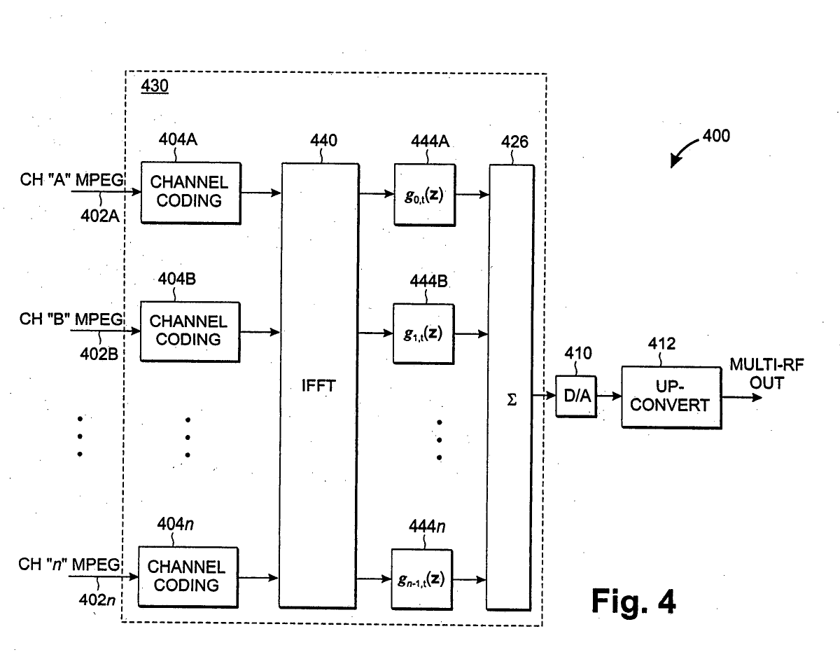

This deficiency can be addressed by combining the pre-IFFT baseband filters and post-IFFT anti-imaging filters into a single post-IFFT filter stage. FIG. 4 shows a multi-channel QAM modulator implemented in this way.

FIG. 4 is a block diagram of an IFFT-based multi-channel QAM modulator 400 wherein two-stage baseband filtering and anti-imaging filtering have been combined into single-stage post-IFFT filtering. In FIG. 4, as in FIGS. 1, 2 and 3, a plurality ‘n’ of channel MPEG (or other digital data) sources 402A, 402B, . . . , 402n are QAM-encoded by a like plurality of respective channel coders 404A, 404B, . . . , 404n. Unlike the implementation described hereinabove with respect to FIG. 3, the QAM-encoded symbol streams are applied directly to the inputs of an IFFT 440, without baseband filtering; therefore the IFFT operates at the QAM symbol rate. Outputs of the IFFT are then processed by a set of ‘n’ time-varying post-IFFT combined channel shaping and anti-imaging interpolation filters 444A, 444B, . . . , 444n, (g_{0,t}(Z), g_{1,t}(z), . . . , g_{n-1,t}(z)) producing filtered outputs that are then summed together by a digital adder 426 to produce a composite digital multi-channel QAM-encoded multiplex in an intermediate frequency (IF) band. This multiplex is then converted to analog form via a D/A converter 410, and frequency shifted to an appropriate frequency band by an up-converter 412 to produce a multi-RF output.

The multi-channel modulator 400 of FIG. 4 requires that all input channels (402‘x’) have the same modulation format and symbol rate, since baseband shaping and anti-imaging are combined in a single filter stage. These are reasonable restrictions and are easily accommodated in any modern digital television transmission scenario.

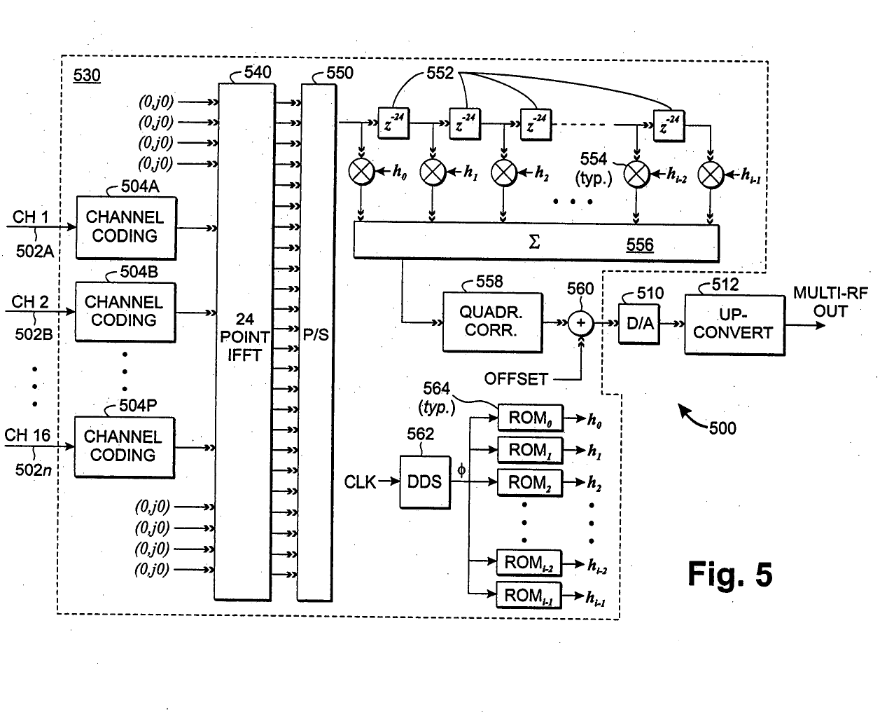

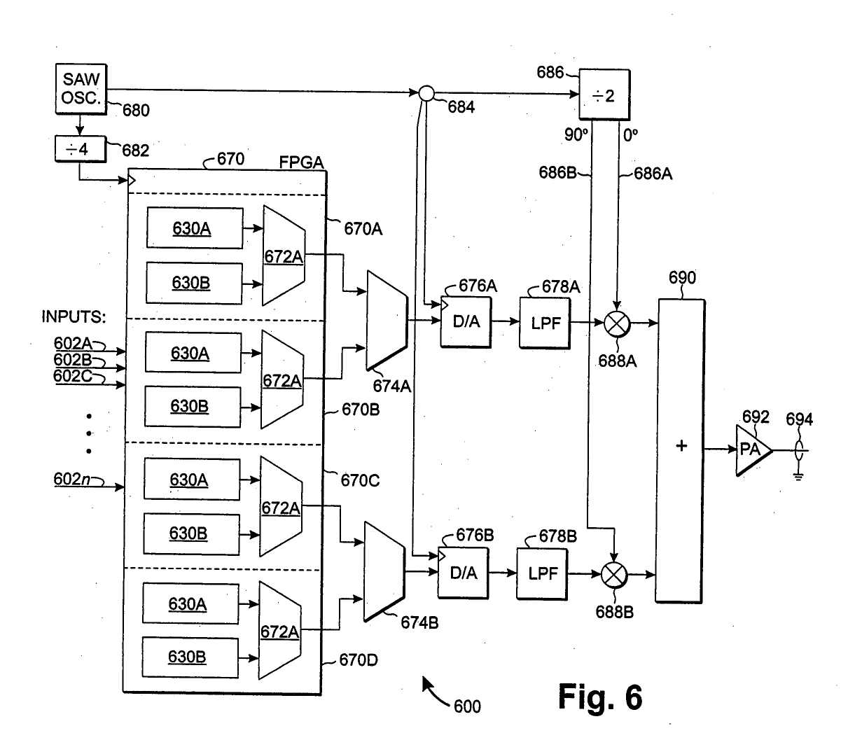

Attention is now directed to a preferred embodiment of the invention as shown and described hereinbelow with respect to FIG. 5. It should be noted that complex quantities such as complex frequencies or complex time-domain signals (each having two values, a “real” part and an “imaginary” part) are represented in FIG. 5 by double-headed arrows. Real values representing single values are represented in FIG. 5 by single-headed arrows.

FIG. 5 is a block diagram of a 16-channel modulator 500 for multi-channel QAM-256 encoding of 16 MPEG signal streams (or any other suitable QAM-256 encodable digital data source, e.g., DOCSIS data) into a multi-channel RF signal for transmission via cable, optical fiber or HFC transmission medium. Thee converter 500 comprises a digital processing portion 530, a “complex” D/A converter 510 and an up-converter 512 which, in practice, would be implemented as two D/A converters (one for “real” and one for “imaginary”) and a quadrature modulator.

In FIG. 5, a plurality of ‘n’ MPEG (or data) streams 502A, 502B, . . . , 502n are QAM-256 encoded according to ITU J.83 annex B to produce a set of complex-frequency QAM symbol representations (indicated by double-headed arrows). A 24 point IFFT function 540 operates at the QAM symbol rate and is employed to convert 24 complex frequency domain inputs to the IFFT 540 into a like number of time-domain outputs. The first four and last four IFFT complex frequency inputs are set to a fixed value of complex “zero” (i.e., (0,j0)). while the complex QAM-encoded streams are applied to the 16 “middle” IFFT inputs. The zero channels create guard bands to ease the requirements on the analog anti-aliasing filters.

The 24 outputs of the IFFT function 540 are serialized by a parallel-to-serial (P/S) function 550 that sequentially shifts out successive complex time-domain values (real/imaginary value pairs) from the IFFT. Each IFFT conversion constitutes an IFFT “frame”, and the P/S function 550 is organized such that 24 shift-outs occur for each IFFT frame, producing a complex-serial stream output with a frame length of 24.

The complex-serial output from the parallel to serial converter 550 is processed by an “i^{th}” order FIR (Finite Impulse Response) digital filter comprising a plurality of i−1 sequentially-connected delay elements 552, “i” complex digital multipliers 554 and a digital adder 556. Each delay element 552 delays the complex serial output of the previous stage by exactly one complete IFFT frame (i.e., 24 complex values). The output from each of the serially connected delay elements 552, therefore, provides a specific delay tap. Each delay tap (and the input to the serially connected array) is multiplied by a real-valued coefficient (hₓ) via a respective one of the complex digital multipliers 554. Since the coefficients hₓ are real-valued, the complex multipliers 554 need not deal with complex cross-products and can be simpler than “true” complex multipliers. (Whereas a “true” complex multiplier requires four multiplications and two additions, the simplified complex-times-real multiplier implementation requires only two multiplications and no additions). The complex product outputs from these multipliers are summed together by the digital adder 556 to produce a filter output.

A coefficient generator comprising a direct digital synthesizer 562 (DDS) acting as an address generator for a set of coefficient ROMs 564 cycles through coefficients for the FIR filter in IFFT frame-synchronous fashion, producing a set of “i” coefficient values (h₀, h₁, h₂, . . . , hᵢ₋₂, hᵢ₋₁) in parallel. The DDS 562 updates the coefficient values for each step of the parallel-to-serial converter 550, repeating the sequence of coefficient values every IFFT frame. In combination, these elements produce an interpolating filter that acts as baseband filter, anti-imaging filter and interpolator (for compensating for the difference between the QAM symbol rate and the channel spacing).

The output of the FIR filter is effectively a multi-channel QAM modulated stream with proper channel spacing in an intermediate frequency (IF) band, interpolated and ready for up-conversion. The output is processed first by a quadrature corrector 558 to pre-correct for non-ideal behavior of a final-stage up-converter 512. An offset is added to the output of the quadrature corrector 558 via a digital adder 560 to pre-compensate for subsequent DC offsets. The offset-compensated result is applied to a D/A converter 510 for conversion to analog form. Note that the FIR filter output, quadrature output, and offset-compensated output are all complex quantities. The digital adder 560 is a “double adder” and the offset is a complex quantity. The D/A converter 510 in fact consists of two converters for separately converting the real and imaginary portions of its complex input to analog form. The complex output of the D/A converter 510 is applied to the final-stage up-converter 512 to frequency-shift the fully compensated and corrected IF multi-channel QAM-encoded stream up to a desired final frequency band to produce a multi-RF output for transmission.

A complete Verilog HDL description of the digital portions of the multi-channel design is provided as an Appendix to this specification.

Those of ordinary skill in the art will immediately understand that the preferred embodiment shown in FIG. 5 represents a specific implementation tailored to currently available digital signal processing, D/A converter and up-converter technologies and that adaptations to that embodiment are readily made to accommodate alternative technologies. For example, given sufficient speed, all or a portion of the multi-channel QAM modulator of FIG. 5 could be implemented on a digital signal processor or general purpose processor, substituting equivalent computer code for digital logic. Such a system could be specifically designed to execute the functions of the present inventive technique or could be implemented on a commercially available processor. In such a system, the code would be store as computer instructions in computer readable media. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C or other object-oriented programming language and development tools. Another embodiment of the invention may be implemented in hardwired circuitry in place of, or in combination with, machine-executable software instructions.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A multi-channel modulator for modulating a plurality of digital data streams onto a single multi-RF output, characterized by:
encoding means for encoding each of the digital data streams into a set of symbol streams;
inverse FFT (IFFT) processing means for simultaneously converting the plurality of symbol streams into a single digital multi-channel IF stream having the multiple symbol streams modulated onto a set of uniformly spaced carrier frequencies in an intermediate frequency band;
digital-to-analog conversion means for converting the single digital multi-channel IF stream into an analog multi-channel IF stream; and
up-conversion means to frequency-shift the analog multi-channel IF stream to a target frequency band on said single multi-RF output.

2. A multi-channel modulator according to claim 1, characterized in that:
the digital data streams are QAM encoded according to ITU J.83 Annex B.

3. A multi-channel modulator according to claim 2, characterized in that:
the digital data streams are 256-QAM encoded.

4. A multi-channel modulator according to claim 2, characterized in that:
the digital data streams are 64-QAM encoded.

5. A multi-channel modulator according to claim 1, further characterized in that:
pre-IFFT baseband filtering means for shaping the symbol streams.

6. A multi-channel modulator according to claim 1, further characterized in that:
post-IFFT anti-imaging filtering means for filtering the digital multi-channel IF streamto achieve channel separation.

7. A multi-channel modulator according to claim 1, further characterized in that:
post-IFFT combined filtering means for performing the combined equivalent of baseband and anti-imaging filtering.

8. A multi-channel QAM modulator according to claim 1, further characterized in that:
interpolation means for compensating for a difference between a QAM symbol rate and a channel spacing.

9. A multi-channel modulator for modulating a plurality of digital data streams onto a single multi-RF output, characterized by:
encoding means for encoding the digital data streams into a like plurality of symbol streams at a symbol rate;
inverse frequency transform processing means having each symbol stream applied to a specific complex frequency input thereof, said transform processing means producing a time-domain signal representative of the plurality of symbol streams modulated onto a set of uniformly spaced carrier frequencies in an intermediate frequency (IF) band;
post-transform means, producing an filtered time-domain signal, for performing the combined equivalent of baseband filtering, anti-imaging filtering and rate interpolation to compensate for a difference between the symbol rate and a channel spacing;
digital-to-analog conversion means for converting the filtered time-domain signal from digital to analog form; and
up-converter means for frequency shifting the analog time-domain signal into a target frequency band on a multi-RF output.

10. A multi-channel modulator according to claim 9, characterized in that:
the inverse transform processing means perform an inverse FFT (IFFT) function.

11. A multi-channel QAM according to claim 9, further characterized in that:
digital quadrature correction means for pre-correcting for non-ideal behavior of the up-converter means.

12. A multi-channel QAM modulator according to claim 9, further characterized in that:
digital offset compensation means for pre-compensating for DC offsets in the digital-to-analog converter means and up-converter means.

13. A method for multi-channel QAM modulation of a plurality of digital data streams onto a single multi-RF output, comprising:
providing a plurality of digital data input streams;
encoding each of the digital data streams into a set of QAM-encoded streams;
processing the QAM-encoded streams via an inverse FFT (IFFT) to modulate the plurality of QAM-encoded streams into a single digital multi-channel IF stream encoding the multiple QAM encoded streams onto a set of uniformly spaced carrier frequencies in an intermediate frequency band;
converting the digital multi-channel IF stream to analog form; and
frequency-shifting the analog multi-channel IF stream to a target frequency band on said single multi-RF output.

14. A method according to claim 13, further comprising:
encoding the digital data streams according to ITU J.83 Annex B.

15. A method according to claim 14, wherein:
the digital data streams are encoded according to 256-QAM.

16. A method according to claim 14, wherein:
the digital data streams are encoded according to 64-QAM.

17. A method according to claim 13, further comprising:
post-IFFT filtering the digital multi-channel IF stream in a combined baseband and anti-imaging filter.

18. A method according to claim 13, further comprising:
interpolating the digital multi-channel IF stream to compensate for a difference between a QAM symbol rate and a channel spacing.

19. A method according to claim 13, further comprising:
providing digital compensation for non-ideal behavior of the frequency-shifting process.

20. A method according to claim 13, further comprising:
providing digital offset compensation for DC offsets in the digital-to-analog conversion and frequency shifting processes.
